(19) United States
(12) Patent Application Publication
(10) Pub. No.: US 2017/0075106 A1
(43) Pub. Date: Mar. 16, 2017

(54) LASER CRYSTALLIZATION APPARATUS

(71) Applicant: SAMSUNG DISPLAY CO., LTD., YONGIN-SI (KR)

(72) Inventors: HONG RO LEE, SEONGNAM-SI (KR); Kl WOON PARK, ASAN-SI (KR); CHUNG HWAN LEE, SEOUL (KR)

(21) Appl. No.: 15/130,265

(22) Filed: Apr. 15, 2016

(30) Foreign Application Priority Data
Sep. 14, 2015 (KR) 10-2015-0129681

(51) Int. Cl. G02B 26/08; G01B 9/02; G01B 11/14; G02B 19/00

(52) U.S. Cl. CPC G02B 26/0816; G02B 19/0028; G02B 19/0047; G01B 9/02; G01B 11/14

(57) ABSTRACT

An exemplary embodiment of the present invention provides a laser crystallization apparatus including a laser generator configured to emit a laser beam. An optical system includes a plurality of lenses and mirrors. The optical system is configured to generate a converted laser beam by optically converting the emitted laser beam. A chamber includes a stage configured to support a substrate. A compensator is configured to uniformly compensate a path of the laser beam that passes toward the substrate by controlling a position of a final-end mirror disposed at an end of the optical system that is opposite to the laser generator.

### CROSS-REFERENCE TO RELATED APPLICATION

This application claims priority under 35 U.S.C. §119 to Korean Patent Application No. 10-2015-0129681, filed in the Korean Intellectual Property Office on Sep. 14, 2015, the disclosure of which is incorporated by reference herein in its entirety.

### (a) TECHNICAL FIELD

Exemplary embodiments of the present invention relate to an apparatus, and more particularly to a laser crystallization apparatus.

### (b) DISCUSSION OF RELATED ART

A laser crystallization apparatus may include a laser generator, an energy source, a plurality of lenses and mirrors, an optical system emitting a laser beam, and a chamber where a substrate may be crystallized by the laser beam emitted from the optical system.

The laser crystallization apparatus may be susceptible to vibration. A laser beam path may have a range of several meters to several tens of meters, and thus even relatively minute vibrations of a lens positioned on the laser beam path may lead to a relatively large vibration on a substrate. Pulse beams may overlap at a predetermined ratio and at an interval of several micrometers or several tens of micrometers for scanning. Thus, beam vibration of ends of the substrate may result in the appearance of blurring or periodic spots. As the resolution of a display device becomes higher, the appearance level of blurring or spotting caused by laser beam vibration may be increased.

In a laser crystallization apparatus, if a vibration measured in real time by a vibration sensor which is disposed at a lower portion thereof is equal to or higher than a predetermined level, the operation of the laser crystallization apparatus may be stopped and a step for finding the cause of the vibration may be executed. When the vibration is sensed both inside and outside of the apparatus, the step for finding the cause of the vibration may be executed by stopping possible vibration-generating sources positioned outside the apparatus one by one. When the vibration is sensed inside the apparatus, the vibration position may be estimated by stopping possible vibration-generating sources positioned inside apparatus one by one or according to a vibration level that is increased by artificially applying vibration for each position.

In general, a passive damper or an active isolator may be disposed on a bottom of the apparatus to prevent an external vibration from being transferred to the apparatus. The quality of the laser crystallization apparatus may be affected even by relatively minute vibrations, and unexpected vibrations may be generated. Thus, even though a dust removing design may be applied to the bottom of the apparatus or the apparatus itself, vibrations may occur.

In the step for finding the cause of the vibration, the vibration may be measured for each position and at each time point. It may take several days or tens of days to remove the cause of the vibration or remodel the apparatus when it is difficult to remove the cause of the vibration. Thus, losses in the utilization of the apparatus and production losses may be increased. Errors generated due to minute lens vibration may cause damage.

### SUMMARY OF THE INVENTION

Exemplary embodiments of the present invention may provide a laser crystallization apparatus which reduces or prevents the generation of blurring or spots caused by vibration on a substrate even when lenses are affected by the vibration.

An exemplary embodiment of the present invention provides a laser crystallization apparatus including a laser generator configured to emit a laser beam. An optical system includes a plurality of lenses and mirrors. The optical system is configured to generate a converted laser beam by optically converting the emitted laser beam. A chamber includes a stage configured to support a substrate. A compensator is configured to uniformly compensate a path of the laser beam that passes toward the substrate by controlling a position of a final-end mirror disposed at an end of the optical system that is opposite to the laser generator.

The compensator may include a first monitoring member configured to measure a path of the laser beam that passes toward the final-end mirror. A mirror driver is configured to move the final-end mirror to a pre-calculated position. A displacement sensor is configured to measure a position of the final-end mirror. A controller is configured to perform a conforming compensation by comparing a measurement position of the final-end mirror measured by the displacement sensor with the pre-calculated position of the final-end mirror. A second monitoring member is configured to measure a path of a laser beam that is reflected by the final-end mirror and passes into the chamber.

The first monitoring member may measure a path of a laser beam that is transmitted into a back end of the final-end mirror.

The displacement sensor may be disposed on a side surface of the final-end mirror to measure a displacement of an edge portion of the final-end mirror.

The displacement sensor may be disposed on an outside of the chamber.

The mirror driver may move the final-end mirror in a direction that is parallel to a relatively longer dimension of the substrate.

The mirror driver may move the final-end mirror in a direction that is perpendicular to a relatively longer dimension of the final-end mirror.

First and second mirror drivers may be disposed at opposite sides of the final-end mirror to substantially simultaneously move the opposite sides of the final-end mirror.

The mirror driver may be disposed at a central portion of the final-end mirror to move the final-end mirror.

The mirror driver may include a piezo motor or a stepping motor.

The second monitoring member may measure a path of a laser beam that is reflected at an edge portion of the laser beam.

The laser crystallization apparatus may include an interferometer disposed above a back surface of the final-end mirror to measure a displacement of the final-end mirror by measuring a distance between the interferometer and the final-end mirror.

According to an exemplary embodiment of the present invention, even when a vibration causes vibration to be generated in the path of the laser beam, a corresponding final-end mirror may be driven by sensing the position of the laser beam in substantially real time, and thus the beam vibration generated in the scan direction might not be transferred to the substrate. Thus, even when vibration is continuously or unexpectedly generated, periodic blurring or spotting may be reduced or eliminated.

The apparatus according to an exemplary embodiment of the present invention might not be stopped to remove the cause of the vibration, and thus it may be possible to increase the utilization of the apparatus.

### BRIEF DESCRIPTION OF THE DRAWINGS

The above and other features of the present invention will become more apparent by describing in detail exemplary embodiments thereof, with reference to the accompanying drawings in which:

FIG. 1 schematically illustrates a laser crystallization apparatus according to an exemplary embodiment of the present invention.

FIG. 2 schematically illustrates a compensator according to an exemplary embodiment of the present invention.

FIG. 3 shows graphs illustrating steps of compensating a laser beam path by a compensator and comparing it with a laser beam path measured by a second monitoring member.

FIG. 4 schematically illustrates a mirror driver according to an exemplary embodiment of the present invention.

FIG. 5 schematically illustrates a mirror driver according to another exemplary embodiment of the present invention.

FIG. 6 schematically illustrates a mirror driver according to another exemplary embodiment of the present invention.

FIG. 7 schematically illustrates a displacement sensor and an interferometer according to an exemplary embodiment of the present invention.

### DETAILED DESCRIPTION OF THE EMBODIMENTS

Exemplary embodiments of the present invention will be described in more detail below with reference to the accompanying drawings in which exemplary embodiments of the present invention are shown. As those skilled in the art would realize, the described exemplary embodiments of the present invention may be modified in various different ways, all without departing from the spirit or scope of the present invention.

The same constituent elements may be denoted by the same reference numerals throughout the specification and drawings.

The drawings may be schematic and might not be illustrated in accordance with a scale. The relative sizes and ratios of the parts in the drawings may be exaggerated or reduced for clarity of description in the specification and drawings. When a part is referred to as being “on” another part, it may be directly on the other part or intervening parts may be present.

As those skilled in the art would realize, the described embodiments may be modified in various different ways, all without departing from the spirit or scope of the present invention.

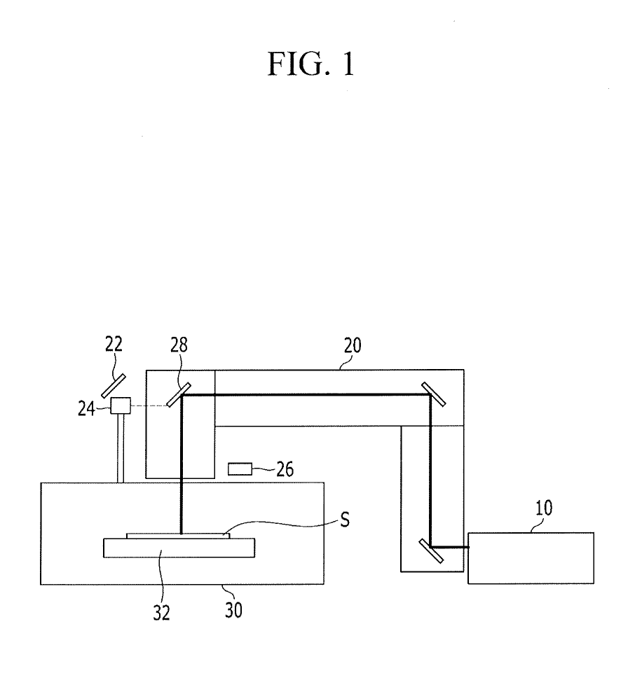

A laser crystallization apparatus according to an exemplary embodiment of the present invention will be described in more detail below with reference to FIG. 1 to FIG. 3.

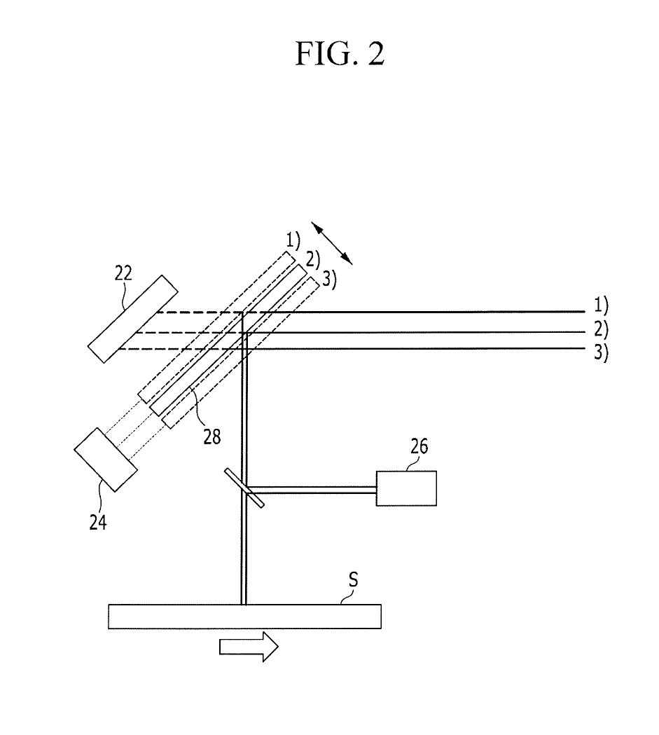

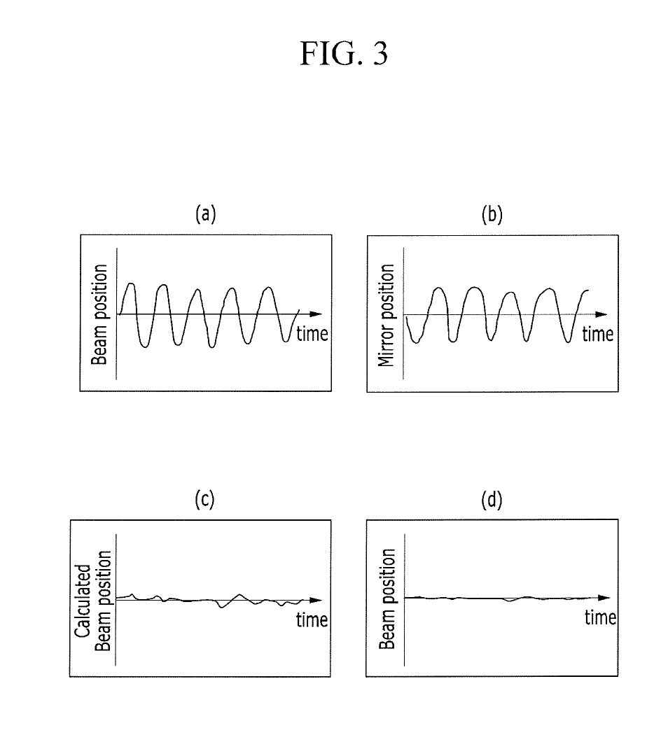

FIG. 1 schematically illustrates a laser crystallization apparatus according to an exemplary embodiment of the present invention. FIG. 2 schematically illustrates a compensator according to an exemplary embodiment of the present invention. FIG. 3 shows graphs illustrating steps of compensating a laser beam path by a compensator and comparing it with a laser beam path measured by a second monitoring member.

Referring to FIG. 1, a laser crystallization apparatus according to an exemplary embodiment of the present invention may include a laser generator 10 generating a laser beam and an optical system 20 converting the laser beam through an optical conversion. A substrate S in which a thin film that is laser-crystallized by transmitting the converted laser beam thereto may be disposed in a chamber 30 including a substrate stage 32 on which the substrate S is disposed. Compensators 22, 50, 24, and 26 may uniformly direct a path of the laser beam.

The laser beam generated by the laser generator 10 may include a p-polarized beam and an s-polarized beam, and may be an excimer laser beam for inducing phase variation of a thin film. The laser beam may be optically converted to crystallize the top surface of the thin film. The thin film may be an amorphous silicon layer, and may be formed by low pressure chemical vapor deposition, atmospheric pressure chemical vapor deposition, plasma enhanced chemical vapor deposition (PECVD), sputtering, or vacuum evaporation.

The optical system 20 may include a plurality of lenses and mirrors adjusting a path of the laser beam, and may optically convert the laser beam. The optical system 20 may include at least one half wave plate (HWP) converting a polarization axis direction of laser beams emitted from the laser generator 10, and at least one mirror totally reflecting the laser beam. The optical system 20 may include at least one polarization beam splitter (PBS) reflecting some of the laser beams and transmitting the others of the laser beams.

In the chamber 30, an atmosphere such as nitrogen (N₂), air, and mixed gas may vary depending on a characteristic of a process, or a preference of a user. Pressure in the chamber 30 may vary depending on a depressurized, pressurized, or vacuum state. Thus, the chamber 30 may be a closed type chamber, which may be isolated from the outside air.

The compensators 22, 50, 24, and 26 may substantially uniformly compensate a path of a laser beam that passes toward the substrate S by controlling a position of a final-end mirror 28 disposed at an end of the optical system 20. The compensators 22, 50, 24, and 26 may adjust a path of a laser beam that passes toward the final-end mirror 28 and is directed by a plurality of mirrors of the optical system 20.

The compensators 22, 50, 24, and 26 include a first monitoring member 22, a mirror driver 50, a displacement sensor 24, a controller and a second monitoring member 26.

The first monitoring member 22 may measure a path of a laser beam that passes toward the final-end mirror 28. The first monitoring member 22 may include a charge-coupled device (CCD) camera. The mirror driver 50 may moves the final-end mirror 28 to a pre-calculated position. The pre-calculated position may be pre-calculated according to a laser beam path that is measured by the first monitoring member 22. The displacement sensor 24 may measure a position of the final-end mirror 28.

The controller may compare the measurement position of the final-end mirror 28 measured by the displacement sensor 24 with the pre-calculated position of the final-end mirror 28. When a difference exists between the measurement position of the final-end mirror 28 and the pre-calculated position of the final-end mirror 28, compensation may be performed. The compensation may be performed by moving the final-end mirror 28 to the pre-calculated position of the final-end mirror by the mirror driver 50 moving the final-end mirror 28.

The second monitoring member 26 may monitor a compensation error of the laser beam and/or the final-end mirror 28 by measuring a path of the laser beam that is reflected by the final-end mirror 28 and passed into the chamber 30. The second monitoring member 26 may include a CCD camera. The CCD camera may be similar to the CCD camera included in the first monitoring member 22.

Referring to FIG. 2, the first monitoring member 22 may be disposed at a back end of the final-end mirror 28. The first monitoring member 22 may measure the laser beam path by using 1% or less of laser beams that are transmitted into the back end of the final-end mirror 28.

The displacement sensor 24 may be disposed on a side surface of the final-end mirror 28. The displacement sensor 24 may measure a position of an edge portion of the final-end mirror 28. The displacement sensor 24 may be disposed on an external part of the chamber 30. The displacement sensor 24 may measure a position of the substrate S. The final-end mirror 28 may recognize a degree of vibration according to a position of the substrate S. The chamber 30 and the substrate stage 32 may each be relatively large and relatively heavy. The chamber 30 and the substrate stage 32 may be disposed at a bottom portion of the laser crystallization apparatus. The chamber 30 and the substrate stage 32 may be relatively unaffected by the vibration. However, the optical system 20 may be relatively small and relatively light. The optical system 20 may be disposed at a top portion of the crystallization apparatus. The optical system 20 may be more significantly affected by the vibration. Thus, the displacement sensor 24 may be separately disposed from the optical system 20, and may be supported by the chamber 30.

The mirror driver 50 may move the final-end mirror 28 to the pre-calculated position that is pre-calculated according to the path of the laser beam measured by the first monitoring member 22. For example, the mirror driver 50 may move the final-end mirror 28 in a direction that is parallel to a relatively longer dimension of the substrate S. The laser beam may vibrate up and down or left and right due to the vibration. The left and right vibration may cause only edge portions of the laser beam to vibrate. However, the edge portions of the laser beam might not be used for laser crystallization. Thus, the left and right vibration might not cause defects.

The up and down vibration may change the distances of the paths of the laser beams, which may result in defects. For example, defects may occur in a thin film that is laser crystallized according to an exemplary embodiment of the present invention. The mirror driver 50 may be configured to move the final-end mirror 28 in the direction that is parallel to the relatively longer dimension of the substrate S (e.g., in a moving direction of the substrate S). The mirror driver 50 may move the final-end mirror 28 in a direction that is perpendicular to the relatively longer dimension of the substrate S (e.g., a height direction of the substrate S). The mirror driver 50 may be configured to move the final-end mirror 28 in a direction that is perpendicular to the relatively longer dimension of the final-end mirror 28. The mirror driver 50 may be configured to move the final-end mirror 28 up, down, left, right or in a diagonal direction, as desired.

Referring to FIG. 2, when the laser beam emitted toward the final-end mirror 28 deviates from a normal path 2), the mirror driver 50 may move the final-end mirror 28 to bring the path of the emitted laser beam in line with the normal path 2). For example, when the laser beam passes along a first path 1) that is above the normal path 2), the mirror driver 50 may move final-end mirror 28 downwardly along the direction that is perpendicular to the relatively longer dimension of the final-end mirror 28. When the laser beam passes along a second path 3) that is below the normal path 2), the mirror driver 50 may move the final-end mirror 28 upwardly along the direction that is perpendicular to the relatively longer dimension of the final-end mirror 28.

Thus, when the mirror driver 50 moves the final-end mirror 28 along the direction that is parallel to the relatively longer dimension of the substrate S, when the laser beam passes along the first path 1), the final-end mirror 28 may be moved to the right. When the mirror driver 50 moves the final-end mirror 28 along the direction that is parallel to the relatively longer dimension of the substrate S, when the laser beam passes along the second path 3), the final-end mirror 28 may be moved to the left.

Referring to FIG. 2 when the final-end mirror 28 is moved to bring the path of the laser beam in line with the normal path 2), the final-end mirror 28 may be moved to the pre-calculated position. The path or deviation of the laser beam may be measured by the first monitoring member 22.

The displacement sensor 24 may measure a movement position of the final-end mirror 28 (e.g., a position to which the final-end mirror 28 has been moved to place it in the pre-calculated position), and the controller may compare the movement direction of the final-end mirror 28 measured by the displacement sensor 24 with the pre-calculated position to which the final-end mirror 28 is moved. When an error is generated between the movement direction of the final-end mirror 28 and the pre-calculated position (e.g., when the movement direction of the final-end mirror 28 does not correspond with the pre-calculated position), the displacement sensor may perform a compensation by controlling the mirror driver 50 to move the final-end mirror 50 to a position corresponding with the pre-calculated position (e.g., by adjusting the movement direction of the final-end mirror 28).

Referring to FIG. 3, a beam position of the laser beam may be measured by the first monitoring member 22 as shown in FIG. 3(a), and a mirror position to which the final-end mirror 28 is moved may be measured by the displacement sensor 24 as shown in FIG. 3(b). The graph shown in FIG. 3(c) is obtained by combining the beam position of the laser beam measured by the first monitoring member 22 and the mirror position to which the final-end mirror 28 is moved measured by the displacement sensor 24.

FIG. 3(d) is a graph illustrating the path of the laser beam that is reflected by the final-end mirror 28 and passes into the chamber 30, which may be measured by the second monitoring member 26.

The second monitoring member 26 may measure the path of the laser beam that is reflected by the final-end mirror 28 and passes into the chamber 30, and may also measure a path of a laser beam that is reflected at an edge portion of the laser beam.

A first beam path shown in FIG. 3(c) obtained by combining the beam position of the laser beam measured by the first monitoring member 22 and the mirror position to which the final-end mirror 28 is moved measured by the displacement sensor 24 may be compared with the path of the laser beam measured by the second monitoring member 26, which is shown in FIG. 3(d) in order to reduce a difference therebetween. When the difference between the combined beam position of the laser beam measured by the first monitoring member 22 and the mirror position to which the final-end mirror 28 is moved measured by the displacement sensor 24 compared with the path of the laser beam measured by the second monitoring member 26 is maintained at a relatively small level, the measurement of the path of the laser beam by the second monitoring member 26 may be omitted.

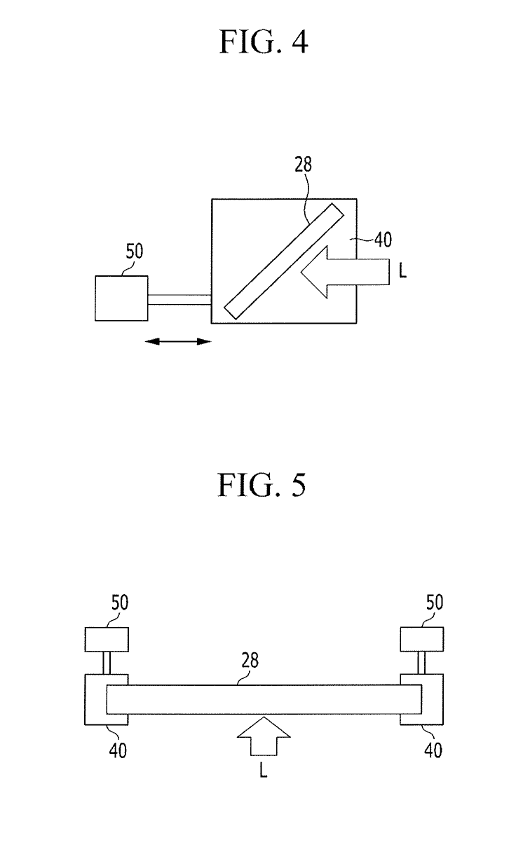

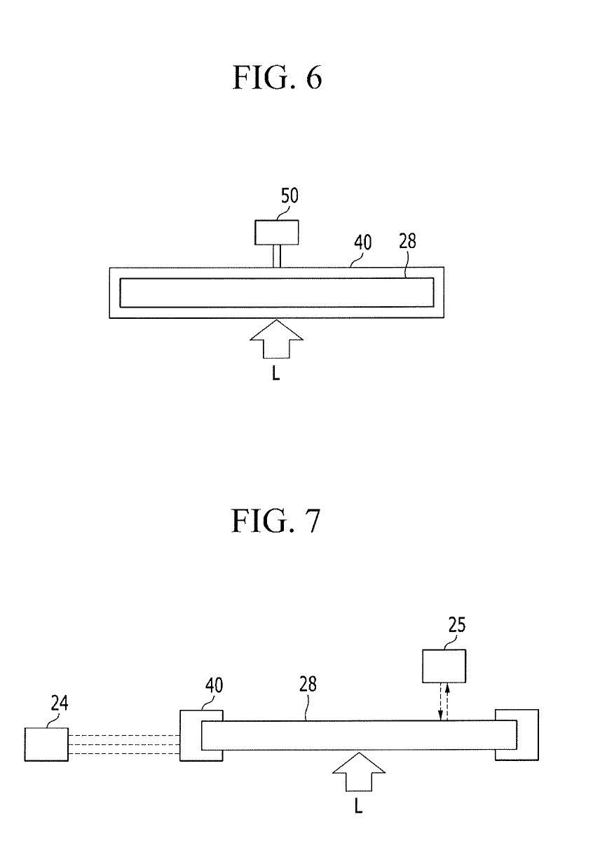

FIG. 4 schematically illustrates a mirror driver according to an exemplary embodiment of the present invention. FIG. 5 schematically illustrates a mirror driver according to another exemplary embodiment of the present invention. FIG. 6 schematically illustrates a mirror driver according to another exemplary embodiment of the present invention.

Referring to FIG. 4, the final-end mirror 28 may be coupled to a mirror mount 40. The mirror mount 40 is connected to the mirror driver 50. A driving shaft of the mirror driver 50 may be coupled to the mirror mount 40. The driving shaft may be linearly moved to linearly move the mirror mount 40. The final-end mirror 28 coupled to the mirror mount 40 may be linearly moved according to movement of the mirror mount 40. For example, the mirror driver 50 may move the final-end mirror 28 in the direction that is parallel to the relatively longer dimension of the substrate S (e.g., in a direction that is parallel to a direction of a laser beam L). The mirror driver 50 may include a piezo motor or a stepping motor.

Referring to FIG. 5, mirror drivers 50 may be respectively disposed at opposite sides of the final-end mirror 28 to simultaneously move the opposite sides of the final-end mirror 28. The mirror drivers 50 may be respectively connected to mirror mounts 40, which support the opposite sides of the final-end mirror 28. The mirror driver 50 may linearly move the respective mirror mounts 40 at the opposite ends of the final-end mirror 28 substantially simultaneously. Thus, the final-end mirror 28 coupled to the mirror mounts 40 may be linearly moved. For example, the mirror drivers 50 may move the final-end mirror 28 along the direction that is parallel to the relatively longer dimension of the substrate S (e.g., in the direction that is parallel to the direction of the laser beam L).

Referring to FIG. 6, the mirror driver 50 may be disposed at a central portion of the final-end mirror 28 to move the central portion of the final-end mirror 28. The mirror driver 50 may be connected to the mirror mount 40, which may support the final-end mirror 28, and thus the mirror driver 50 may linearly move the mirror mount 40 at the central portion of the final-end mirror 28. Thus, the final-end mirror 28 coupled to the mirror mount 40 may be linearly moved. For example, the mirror driver 50 may move the final-end mirror 28 along the direction that is parallel to the relatively longer dimension of the substrate S (e.g., in the direction that is parallel to the direction of the laser beam L).

FIG. 7 schematically illustrates a displacement sensor and an interferometer according to an exemplary embodiment of the present invention.

Referring to FIG. 7, a laser crystallization apparatus according to an exemplary embodiment of the present invention may include an interferometer 25. The interferometer 25 may be disposed above a back surface of the final-end mirror 28 to measure a displacement of the final-end mirror 28 by measuring a distance between the interferometer 25 and the final-end mirror 28. The interferometer 25 may obtain a distance between the interferometer 25 and the final-end mirror 28 by radiating a laser beam onto the back surface of the final-end mirror 28 and measuring an arriving time of a laser beam that is reflected from the final-end mirror 28, thus measuring the displacement of the final-end mirror 28. The interferometer 25 may be disposed above a side surface of the final-end mirror 28 together with the displacement sensor 24, which may measure the displacement of the edge portion of the final-end mirror 28, thus increasing the accuracy of the measurement of the displacement of the final-end mirror 28.

According to an exemplary embodiment of the present invention, even when a vibration causes vibration to be generated in the path of the laser beam, a corresponding final-end mirror 28 may be driven by sensing the position of the laser beam substantially in real time, and thus the beam vibration generated in the scan direction might not be transferred to the substrate. Thus, even when vibration is continuously or unexpectedly generated, periodic blurring or spotting may be reduced or prevented.

The apparatus according to an exemplary embodiment of the present invention might not be stopped to remove the cause of vibration, and thus it is possible to increase the utilization of the apparatus.

While the present invention has been shown and described with reference to the exemplary embodiments thereof, it will be apparent to those of ordinary skill in the art that various changes in form and detail may be made thereto without departing from the spirit and scope of the present invention.

What is claimed is:

1. A laser crystallization apparatus comprising:
a laser generator configured to emit a laser beam;
an optical system including a plurality of lenses and mirrors, wherein the optical system is configured to generate a converted laser beam by optically converting the emitted laser beam;
a chamber including a stage configured to support a substrate; and
a compensator configured to uniformly compensate a path of the laser beam that passes toward the substrate by controlling a position of a final-end mirror disposed at an end of the optical system that is opposite to the laser generator.

2. The laser crystallization apparatus of claim 1, wherein the compensator includes:
a first monitoring member configured to measure a path of the laser beam that passes toward the final-end mirror;
a mirror driver configured to move the final-end mirror to a pre-calculated position;
a displacement sensor configured to measure a position of the final-end mirror;
a controller configured to perform a conforming compensation by comparing a measurement position of the final-end mirror measured by the displacement sensor with the pre-calculated position of the final-end mirror; and
a second monitoring member configured to measure a path of a laser beam that is reflected by the final-end mirror and passes into the chamber.

3. The laser crystallization apparatus of claim 2, wherein the first monitoring member measures a path of a laser beam that is transmitted into a back end of the final-end mirror.

4. The laser crystallization apparatus of claim 2, wherein the displacement sensor is disposed on a side surface of the final-end mirror to measure a displacement of an edge portion of the final-end mirror.

5. The laser crystallization apparatus of claim 2, wherein the displacement sensor is disposed on an outside of the chamber.

6. The laser crystallization apparatus of claim 2, wherein the mirror driver moves the final-end mirror in a direction that is parallel to a relatively longer dimension of the substrate.

7. The laser crystallization apparatus of claim 2, wherein the mirror driver moves the final-end mirror in a direction that is perpendicular to a relatively longer dimension of the final-end mirror.

8. The laser crystallization apparatus of claim 2, wherein first and second mirror drivers are disposed at opposite sides of the final-end mirror to substantially simultaneously move the opposite sides of the final-end mirror.

9. The laser crystallization apparatus of claim 2, wherein the mirror driver is disposed at a central portion of the final-end mirror to move the final-end mirror.

10. The laser crystallization apparatus of claim 2, wherein the mirror driver includes a piezo motor or a stepping motor.

11. The laser crystallization apparatus of claim 2, wherein the second monitoring member measures a path of a laser beam that is reflected at an edge portion of the laser beam.

12. The laser crystallization apparatus of claim 2, further comprising
an interferometer disposed above a back surface of the final-end mirror to measure a displacement of the final-end mirror by measuring a distance between the interferometer and the final-end mirror.

13. The laser crystallization apparatus of claim 1, wherein a substrate is disposed on the stage, and wherein the substrate includes a thin film that is laser-crystallized by radiating the converted laser beam to the substrate.

14. A laser crystallization apparatus comprising:
a laser generator configured to emit a laser beam;
an optical system including a final-end mirror;
a chamber including a stage configured to support a substrate; and
a compensator configured to uniformly compensate a path of the laser beam that passes toward the substrate by controlling a position of the final-end mirror, wherein a mirror driver moves the final-end mirror in a direction that is perpendicular to a relatively longer dimension of the final-end mirror.

15. The laser crystallization apparatus of claim 14, wherein the compensator includes:
a first monitoring member configured to measure a path of the laser beam that passes toward the final-end mirror;
a displacement sensor configured to measure a position of the final-end mirror;
a controller configured to perform a conforming compensation by comparing a measurement position of the final-end mirror measured by the displacement sensor with the pre-calculated position of the final-end mirror; and
a second monitoring member configured to measure a path of a laser beam that is reflected by the final-end mirror and passes into the chamber.

16. The laser crystallization apparatus of claim 15, wherein the first monitoring member measures a path of a laser beam that is transmitted into a back end of the final-end mirror.

17. The laser crystallization apparatus of claim 15, wherein the displacement sensor is disposed on a side surface of the final-end mirror to measure a displacement of an edge portion of the final-end mirror.

18. The laser crystallization apparatus of claim 15, wherein the displacement sensor is disposed on an outside of the chamber.

19. The laser crystallization apparatus of claim 15, wherein the mirror driver moves the final-end mirror in a direction that is parallel to a relatively longer dimension of the substrate.

20. The laser crystallization apparatus of claim 15, wherein first and second mirror drivers are disposed at opposite sides of the final-end mirror to substantially simultaneously move the opposite sides of the final-end mirror.
